(19) United States
(12) Patent Application Publication
(10) Pub. No.: US 2023/0378440 A1
(43) Pub. Date: Nov. 23, 2023

(54) PROTECTIVE COATINGS FOR CATHODE POWDERS

(71) Applicant: Rivian IP Holdings, LLC, Irvine, CA (US)

(72) Inventors: Rubayyat Mahbub, Fremont, CA (US); Majid Talebiesfandarani, Emeryville, CA (US); Soo Kim, Fremont, CA (US); Muratahan Aykol, San Jose, CA (US)

(21) Appl. No.: 17/751,118

(22) Filed: May 23, 2022

(51) Int. Cl. H01M 4/36; H01M 10/0525; H01M 10/0562; H01M 4/525; H01M 4/505; H01M 4/485; C01G 53/00

(52) U.S. Cl. CPC H01M 4/366; H01M 10/0525; H01M 10/0562; H01M 4/525; H01M 4/505; H01M 4/485; C01G 53/50; H01M 2300/0068; H01M 2004/028

(57) ABSTRACT

A cathode active material comprising: a nickel-rich lithium transition metal oxide; a first coating material on a surface of the nickel-rich lithium transition metal oxide; and a second coating material comprising a lithium metal oxide; wherein the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide, and the second coating material is different from the first coating material and the nickel-rich lithium transition metal oxide.

### SUMMARY

In one aspect, an cathode active material includes a nickel-rich lithium transition metal oxide; a first coating material on a surface of the nickel-rich lithium transition metal oxide; and a second coating material comprising a lithium metal oxide; wherein the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide. In some embodiments, the second coating material is other than a lithium aluminum oxide. In other embodiments, the second coating material exhibits: a chemical stability greater than that of LiNbO₃; a LiF stability score greater than that of LiNbO₃; and a PF₅⁻ reactivity score greater than that of LiNbO₃; a thermodynamic phase stability or synthesizability measured by energy above hull <100 meV/atom; a band gap energy greater than 1 eV; or a combination of any two or more thereof. In some embodiments, the second coating material is not the same as the first coating material.

In another aspect, a battery includes a cathode, an anode, and a solid-state electrolyte, wherein: the cathode comprises: a nickel-rich lithium transition metal oxide; a first coating material on a surface of the nickel-rich lithium transition metal oxide; and a second coating material comprising a lithium metal oxide; wherein the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide.

In another aspect, a battery includes a plurality of battery cells, each cell as described herein. Such batteries may comprise a bank of battery cells, a power unit in a vehicle, or a battery or battery cell within an electric vehicle. In further aspect, an electric vehicle comprises any of the batteries or battery cells embodied herein.

### BRIEF DESCRIPTION OF THE DRAWINGS

FIG. 1 is a schematic illustration of Li containing coating material on a high-nickel content lithium metal oxide particulate material, according to various embodiments.

FIG. 2 is a workflow diagram of the selection criteria, according to various embodiments.

FIG. 3 is a chemical reaction profile between NMC811 and Al₂O₃, where the x-axis is the molar fraction of NMC811, where x=0 is 100% NMC811, and where x=1 is 100% Al₂O₃, the y-axis is the reaction enthalpy in eV/atom, according to the examples. It is noted that the most stable reaction between NMC811 and Al₂O₃ occurs when x=0.319, with Eᵣₓₙ=−0.033 eV/atom.

FIG. 4 is an illustration of a cross-sectional view of an electric vehicle, according to various embodiments.

FIG. 5 is a depiction of an illustrative battery pack, according to various embodiments.

FIG. 6 is a depiction of an illustrative battery module, according to various embodiments.

FIGS. 7A, 7B, and 7C are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The present disclosure relates to second coating materials, of formula LiₐM_{b}O_{c}, that provide chemical and electrochemical stability for high nickel content lithium metal oxides (i.e. >70 wt % Ni), such as lithium nickel manganese cobalt oxide-based cathode active materials (“NMC” materials). The NMC materials are commercially available, typically, with a binary oxide coating material such as Al₂O₃, or with more advanced ternary coating, such as a lithium metal oxide that may be LiNbO₃. This disclosure augments those commercially available coated NMC materials with a second coating material that is a lithium metal oxide of formula LiₐM_{b}O_{c}, where M is Bi, Cr, Fe, Ga, Ge, Hf, Mn, Mo, Nb, Sb, Si, Sn, Ti, V, or Zr; a is 0, 1, 2, 3, 4, 5, 6, 7, or 8; b is 0, 1, or 2; and c is 1, 2, 3, 4, 5, 6, 7, 8, or 9. Such materials were identified as having a chemical stability to nickel-rich cathode active materials (e.g., NMC) of greater than that of a Al₂O₃ coating, a chemical stability greater than that of a LiNbO₃ coating with commercially applied coatings on nickel-rich cathode active materials (e.g., NMC), a LiF Stability Score greater than that of LiNbO₃, and a PF₅⁻ Reactivity Score greater than that of LiNbO₃. The materials are believed to provide additional protection to nickel-rich cathode materials (e.g., NMC) material while not interfering with SEI (solid electrolyte interphase) formation.

As used herein, the term “chemical stability,” in reference to a certain coating material (i.e. Al₂O₃ or LiNbO₃) is reference to a predictive model with regard to the reaction between the NMC material that is modeled (NMC811) and a given metal oxide or lithium metal oxide coating material. As noted in the examples, the calculation is based upon a determination of the enthalpy of reaction, Eᵣₓₙ, for the reaction, and then normalizing it to Al₂O₃. In the case of Al₂O₃, the Eᵣₓₙ is about −0.033 eV/atom. Where Eᵣₓₙ is about 0, no reaction is predicted to occur. Such values may also be normalized to the value determined for Al₂O₃ for a direct comparison. Similar predictive models may be based upon LiNbO₃ as a ternary oxide coating, where the Erxn for that material is about −0.011 eV/atom.

As used herein, the LiF, LiOH, and/or PF₅⁻ scores are determined based upon the model reaction that is to be run. The molar ratio of components (LiF, LiOH, or PF₅⁻) to Li-M-O is first determined (ratio A). The ratio is then normalized to the ratio for the baseline reaction of LiNbO₃ by dividing ratio A (for LiNbO₃) by ratio B (for the Li-M-O of interest) to arrive at Value (I). The enthalpy of reaction (Eᵣₓₙ) in eV/atom is then determined from the calculation, however this is then normalized to the Eᵣₓₙ for LiNbO₃ dividing by Eᵣₓₙ (for LiNbO₃) by the Eᵣₓₙ (for the Li-M-O of interest) to arrive at Value II. Value I and II are then summed, however they are based upon molar ratios. To convert the values to weight-based values, the sum is then divided by the molecular weight of the Li-M-O multiplied by 1000. The LiF, LiOH and/or PF₅⁻ score is then determined by dividing the per weight value for the LiNbO₃ by the per weight value of the Li-M-O multiplied by 100. Expressed another way, the LiF, LiOH and/or PF₅⁻ score is a percentage improvement (or diminution) for that reaction compared to the baseline LiNbO₃ value. Illustrative calculations are shown in the examples.

Coatings, for example commercially-feasible oxide coatings, for NMC materials are used to (1) assist in formation of a modified solid electrolyte interface (SEI), to help stabilize the interface between the electrode and the electrolyte in a battery in the event of electrolyte decomposition; (2) improve the electrolyte wetting to ensure uniform Li⁺ ion insertion and de-insertion; and (3) suppress the surface phase transition of cathode materials (i.e., surface decomposition) as a physical barrier.

A battery goes through a series of formation cycles before being used by the consumer. Among many steps or a formation cycle, NMC materials incorporated in a cathode in a battery are also charged to high voltage regions. As used herein, the high voltage region refers to voltages above about 4 V vs. Li/Li⁺. During this formation cycle, electrolyte decomposition typically takes place at a voltage of about 4.2 V vs. Li/Li⁺. Such decomposition may also help the formation of cathode solid electrolyte interphase (c-SEI). In order to better yield c-SEI composition that can protect the electrode materials enabling longer cycle life, Al₂O₃ has been extensively used a binary oxide coating material.

From a cell cycling perspective, it is beneficial to incorporate Al₂O₃, or another binary metal oxide material, as electrode coating materials. However, it has been found that Al₂O₃ coating materials consume Li ions and undergo a phase transition. For example, Ni-rich cathode materials such as LiNi_{0.8}Mn_{.01}Co_{0.1}O₂ (e.g. “NMC811”), have been found to react with Al₂O₃ according to the following reaction:

0.319 LiNi_{0.8}Mn_{0.1}Co_{0.1}O₂+0.681 Al₂O₃→0.082 Ni₃O₄+0.006 Li₄MnCo₅O₁₂ +0.003 LiO₈+0.273 LiAl₅O₈+0.008 Li₂Mn₃NiO₈

Such a reaction has an enthalpy of reaction (Eᵣₓₙ) of −0.033 eV/atom. Al₂O₃, and other binary metal oxides, may limit the Li ion conductivity at the cathode and electrolyte interface and increase impedance or overpotential of the battery.

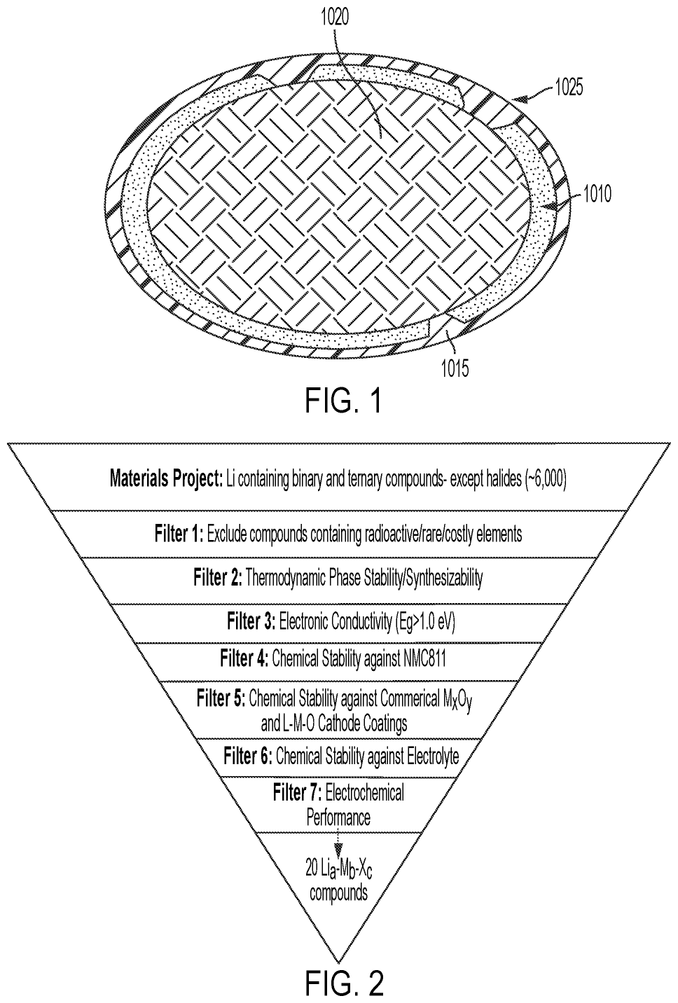

Applying a dual coating on NMC particles using a binary metal oxide and a Li-M-O coating may be used to further protect the particles. The materials described herein are “second” coating materials that: (i) exhibit good Li⁺ ionic conductivity, (ii) are stable toward NMC materials, and (iii) are stable toward other commonly applied NMC coating materials. Such second coating materials, i.e. LiₐM_{b}O_{c} materials, may be used with or over the conventional (i.e. “first”) cathode coating materials, as illustrated in FIG. 1.

In a first aspect, a cathode active material includes a nickel-rich lithium transition metal oxide, a first coating material on a surface of the nickel-rich lithium transition metal oxide, and a second coating material that includes a lithium metal oxide coating. In such cathode active materials, the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide, and the second coating material is different from the first coating material and the nickel-rich lithium transition metal oxide.

In any of the above embodiments, the nickel-rich lithium transition metal oxide comprises a lithium nickel manganese cobalt oxide (“LiNMC”), a lithium nickel cobalt aluminum oxide (“LiNCA”), or a lithium nickel manganese cobalt aluminum oxide (“LiNMCA”) material. The nickel-rich lithium transition metal oxide may be the bulk electrode active material present in the electrode. Such materials include greater than 70 wt % Ni. In various embodiments, this may be greater than 80 wt % Ni, greater than 85 wt % Ni, or from about 70 wt % to 96 wt % Ni. In any such embodiments, the nickel-rich lithium transition metal oxide may be, or include, LiNi_{0.8}Mn_{0.1}Co_{0.1}O₂. In the cathode active materials, the second coating may be other than a lithium aluminum oxide.

As noted above, the second coating materials are desirably more stable than the corresponding first coating materials that are typically applied commercially. Accordingly, in some embodiments, the second coating material exhibits a NMC chemical stability greater than that of Al₂O₃; a LiF stability score greater than that of LiNbO₃; a PF₅⁻ reactivity score greater than that of LiNbO₃; a thermodynamic phase stability or synthesizability measured by energy above hull <100 meV/atom; a band gap energy greater than 1 eV; or, a combination of any two or more such properties thereof. In some embodiments, the second coating material is material having a band gap of greater than 1 eV and an ionic conductivity greater than that of the first coating material. In any such embodiments, a NMC (or LiF) stability score is the ratio of the reactivity of the coating with NMC (or LiF), such as measured by the reaction energy with NMC (or LiF) in reference to a baseline coating material, such as Al₂O₃ and/or LiNbO₃, where a relatively lower reactivity with NMC (or LiF) dictates a higher stability score and a relatively higher reactivity dictates a lower stability score.

In any of the above embodiments, the first coating material may include a binary metal oxide coating. Alternatively, a ratio of the first coating material to the second coating material is from 1:1, 2:1, 3:1, 4:1, or 5:1 on a wt % basis.

In any of the above embodiments, the cathode active material may be one where the lithium metal oxide coating (i.e., the second coating material) exhibits a nickel-rich transition metal oxide) stability score of greater than that of Al₂O₃ coating. Such coating materials are used at a level sufficient to provide additional protection to the cathode material. For example, this may include where the lithium metal oxide is present from greater than 0.01 wt % to about 5.0 wt %. The thickness of the coating may also play in role in durability, but it may also be a hindrance to current flow. Accordingly, the lithium metal oxide coating may have a thickness on the bulk cathode active material of about 5 nm to about 2 μm.

Referring to FIG. 1, in some embodiments, the first coating material 1010 may include discontinuous regions 1015 of coating on the high-nickel content lithium metal oxide 1020, and where a portion of the second coating material 1025 is formed in the discontinuous regions 1015 of the first coating material. In other embodiments, a portion of the second coating material 1025 is formed in the discontinuous regions 1015 of the first coating material 1010 and has a greater thickness than other portions of the lithium metal oxide coating formed as an overcoating.

In any of the above embodiments, the first coating material may include Al₂O₃, HfO₂, MgO, MnO₂, Nb₂O₅, SnO₂, TiO₂, WO₃, Y₂O₃, ZrO₂, LiNbO₃, LiBO₃, Li₂WO₄, Li₄WO₅, or a mixture of any two or more thereof; and the lithium metal oxide of the second coating material is of formula LiₐM_{b}O_{c}, where M is Bi, Cr, Fe, Ga, Ge, Hf, Mn, Mo, Nb, Sb, Si, Sn, Ti, V, or Zr, a is 0, 1, 2, 3, 4, 5, 6, 7, or 8; bis 0, 1, or 2; and c is 1, 2, 3, 4, 5, 6, 7, 8, or 9. Illustrative second coating materials include, but are not limited to, Li₃SbO₄, Li₃VO₄, Li₂SnO₃, Li₆Ge₂O₇, Li₂FeO₃, Li₃NbO₄, Li₂MnO₃, Li₂MoO₄, Li₄MoO₅, Li₂CrO₄, Li₂HfO₃, LiGaO₂, Li₂GeO₃, Li₃BiO₄, Li₂ZrO₃, Li₈Nb₂O₉, Li₂TiO₃, Li₄GeO₄, Li₄SiO₄, or a mixture of any two or more thereof. In some embodiments, the second coating material may be Li₃SbO₄, Li₃VO₄, Li₂SnO₃, Li₆Ge₂O₇, Li₂FeO₃, Li₃NbO₄, Li₂MnO₃, Li₂MoO₄, Li₄MoO₅, Li₂CrO₄, Li₂HfO₃, LiGaO₂, Li₂GeO₃, or a mixture of any two or more thereof. In some embodiments, the second coating material may be Li₃SbO₄, Li₃VO₄, Li₂SnO₃, Li₆Ge₂O₇, Li₂FeO₃, or a mixture of any two or more thereof.

In any of the above embodiments, the second coating material is other than Al₂O₃, HfO₂, MgO, MnO₂, Nb₂O₅, SnO₂, TiO₂, WO₃, Y₂O₃, ZrO₂, LiNbO₃, LiBO₃, Li₂WO₄, or Li₄WO₅.

In another aspect, a battery includes a cathode, an anode, and a solid-state electrolyte, where the cathode includes a nickel-rich lithium transition metal oxide, a first coating material on a surface of the nickel-rich lithium transition metal oxide, and a second coating material comprising a lithium metal oxide coating. In such materials, the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide, and the second coating material is different from the first coating material and the nickel-rich lithium transition metal oxide. The nickel-rich transition metal oxide may be a single crystal, polycrystalline, or blended (e.g., different size of single crystals, polycrystals, or mixture of single- and polycrystals), where the first and/or second coating material may be different based on the size, morphology, and/or crystallinity.

It is understood that in the commercial coating of the cathode active materials, commercial (i.e. the first) coating materials include voids and other irregularities on the surface of the cathode active material. As the second coating material is deposited onto the active material, they typically nucleate near grain boundaries of the first coating material or the cathode materials. For example, they may deposit on the cathode materials next to the first coating material. The may also then fill the voids or uncoated areas from the first coating deposition and grow in thickness in those areas as the deposition proceeds. Where the second coating material is deposited on top of the first coating material , the second coating material may be thinner. For example, in some embodiments, a thickness of the first and/or second coating material may be about 5 nm to about 2 μm.

In some embodiments, the first coating material is formed in discontinuous regions on the surface of the high-nickel content lithium transition metal oxide, and the second coating material, i.e. the lithium metal oxide coating material, is formed in the discontinuous regions of the first coating material. A portion of the lithium metal oxide coating formed in the discontinuous regions of the first coating coating material may have a greater thickness than other portions of the lithium metal oxide coating formed as an overcoating.

According to various embodiments, the nickel-rich lithium transition metal oxide, first coating material, and second coating material are as described throughout this disclosure. The electrolyte may be a solid-state electrolyte that includes materials such as, but not limited to, organic polymeric solid-state electrolytes, oxide-based inorganic solid electrolytes, phosphate-based inorganic solid electrolytes, sulfide-based inorganic solid electrolytes (e.g., Li₃PS₄, Li₇P₃S₁₁, Li₂S-P₂S₅, and Li₆PS₅Cl), organic-inorganic composite solid-state electrolytes or quasi-solid-state electrolyte comprising a liquid electrolyte in a solid matrix.

In a lithium ion battery comprising a liquid electrolyte, the liquid electrolyte may comprise a non-aqueous polar solvent, for example a carbonate such as ethylene carbonate, propylene carbonate, diethyl carbonate, ethyl methyl carbonate, dimethyl carbonate, or a mixture of any two or more thereof. The electrolytes may also include other additives such as, but not limited to, vinylidene carbonate, fluoroethylene carbonate, ethyl propionate, methyl propionate, methyl acetate, ethyl acetate, or a mixture of any two or more thereof. The lithium salt of the electrolyte may be any of those used in lithium battery construction including, but not limited to, lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte from greater than 0.1 M to about 10 M, with typical range from 1 M to 1.5 M of lithium salt in the given solvent system.

The cathode, anode, or both the cathode and anode of the battery may include other materials such as, but not limited to, a conducive carbon material, a binder, and a current collector. Generally, the conductive carbon species may include graphite, carbon black, carbon nanotubes, and the like. Illustrative conductive carbon species include graphite, carbon black, Super P carbon black material, Ketj en Black, Acetylene Black, SWCNT, MWCNT, graphite, carbon nanofiber, and/or graphene, graphite.

Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA) , poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Illustrative current collectors may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof In another embodiment, the metal foils maybe coated with carbon: e.g., carbon-coated Al foil, and the like.

In the batteries, illustrative anodes may include the above materials, a Li metal anode, or a silicon-based anode. In some embodiments, the anode comprises a lithium metal foil, for example in a solid-state battery comprising a solid-state electrolyte. In some embodiments, the anodes may also include a current collector, a conductive carbon, a binder, and other additives, as described above with regard to the cathode current collectors, conductive carbon, binders, and other additives. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material.

To prepare the dual coated cathode active materials, a sol-gel process or a solid-state process may be used. In the sol-gel process a solution phase mixture of prcursors are mixed in water a suitable solvent or mixture of solvents to form a gelled material with the cathode active material, followed by solvent removal. Sintering of the gel then forms the oxide coating on the surface of the cathode active material. In the solid-state process, precursors of metal oxides or other materials are mixed with the cathode active material to form the coating(s).

Accordingly, in another aspect, a process for preparing a dual coated cathode active material is provided. The sol-gel process includes mixing lithium and a compound of formula M_{d}(OR)ₑ in water or other suitable solvent, to form a first solution, where M is Bi, Cr, Fe, Ga, Ge, Hf, Mn, Mo, Nb, Sb, Si, Sn, Ti, V, or Zr; R is alkyl; d is 1, 2, 3, or 4; and e is 1, 2, 3, or 4. The compound of formula Md(OR)e may be a metal acetate compound (M-O-Ac). To the solution is added a nickel-rich lithium transition metal oxide that includes a first coating material. The solution is then heated, and the solvent removed to form a residual gel. The residual gel is then sintered to form the dual coated cathode active material. In any of the above embodiments, the heating the first solution includes heating to about 50° C. to about 100° C. In any of the above embodiments, the sintering the residual gel includes heating the residual gel to about 300° C. to about 1000° C. The sintering may be conducted in air, oxygen, or inert atmosphere.

In some embodiments, the solvent is an alcohol. Illustrative alcohols include, but are not limited to, methanol, ethanol, propanol, butanol, pentanol, hexanol, or an isomer thereof.

In another aspect, a process for preparing a dual coated cathode active material by a solid state-process is provided. The process may include mixing a high-nickel content lithium transition metal oxide having a first coating thereon, with a second coating material. In some embodiments, the high-nickel content lithium transition metal oxide is a particulate lithium nickel manganese cobalt oxide (“LiNMC”) or a lithium nickel cobalt aluminum oxide (“LiNCA”) or lithium nickel manganese cobalt aluminum oxide (“LiNMCA”) material. In various embodiments, the first coating material may be Al₂O₃, HfO₂, MgO, MnO₂, Nb₂O₅, SnO₂, TiO₂, WO₃, Y₂O₃, ZrO₂, LiNbO₃, Li₂WO₄, Li₄WO₅, or a mixture of any two or more thereof. In other embodiments, the second coating material may be a lithium metal oxide of formula LiaMbOc, where M is Bi, Cr, Fe, Ga, Ge, Hf, Mn, Mo, Nb, Sb, Si, Sn, Ti, V, or Zr; a is 0, 1, 2, 3, 4, 5, 6, 7, or 8; b is 0, 1, or 2; and c is 1, 2, 3, 4, 5, 6, 7, 8, or 9.

In another embodiment, a process for preparing a dual coated cathode active material by a solution-phase method is provided. Precusor chemicals containing stoichiometric amounts of Li and metal for the targeted coating material may be dissolved in the aqeuous solution, acid/base solution, or in organic solvent, followed by adding the bulk particulate cathode active material (e.g., NMC powder), and mixing. Furthermore, a secondary heat treatment step to form the NMC coated by lithium metal oxide of formula LiₐM_{b}O_{c}. For example, a metal-containing precursor (i.e. the metal of the second coating material) may include a metal nitrate, chloride, sulfate, etc. that is dissolved in water or an organic solvent. This method may include co-precipitation methods in a continuously stirred tank reactor (CSTR). The precursor solution is then mixed with the NMC powder at room temperature or elevated temperature and an aging time is allowed to proceed. The aging time may varying from about 5 min to about 24 hours, or longer. The pH of the solution may be controlled by the presence of acid or base in order to precipitate well-mixed precursor compounds. Then, the NMC powder, coated with the metal precursor is then isolated and annealed at elevated temperature. Illustrative elevated temperatures are about 200, 400, 600, 800, and 1,000° C., or value ranges between any two thereof. The aging time may be any of the following values or in a range of any two of the following values: 1, 2, 3, 4, 8, 12, 16, 24, 36, 48, 60, and 72 hours. Depending on the choice of coatings, reducing/oxidizing conditions may vary by presence of different gas agents including but not limited to N₂, O₂, Air, Ar, H₂, CO, CO₂, mixture thereof, etc.

In another aspect, a process is provided for manufacturing an electrode for a lithium ion battery. Such processes include mixing a conductive carbon, a binder, and a high-nickel content lithium transition metal oxide having a first coating material and a second coating material in a solvent to form a slurry. The slurry is then coated onto an electrode current collector and the solvent removed. In such an aspect, the high-nickel content lithium transition metal oxide may be a particulate lithium nickel manganese cobalt oxide (“LiNMC”) or a lithium nickel cobalt aluminum oxide (“LiNCA”) or lithium nickel manganese cobalt aluminum oxide (“LiNMCA”) material. Additionally, the first coating material may be Al₂O₃, HfO₂, MgO, MnO₂, Nb₂O₅, SnO₂, TiO₂, WO₃, Y₂O₃, ZrO₂, LiNbO₃, Li₂WO₄, Li₄WO₅, or a mixture of any two or more thereof. The second coating material may be a lithium metal oxide of formula LiₐM_{b}O_{c}, where M may be Bi, Cr, Fe, Ga, Ge, Hf, Mn, Mo, Nb, Sb, Si, Sn, Ti, V, or Zr; a may be 0, 1, 2, 3, 4, 5, 6, 7, or 8; b may be 0, 1, or 2; and c may be 1, 2, 3, 4, 5, 6, 7, 8, or 9.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles. In another aspect, a plurality of battery cells as described above may be used to form a battery and/or a battery pack that may find a wide variety of applications such as general storage, or in vehicles.

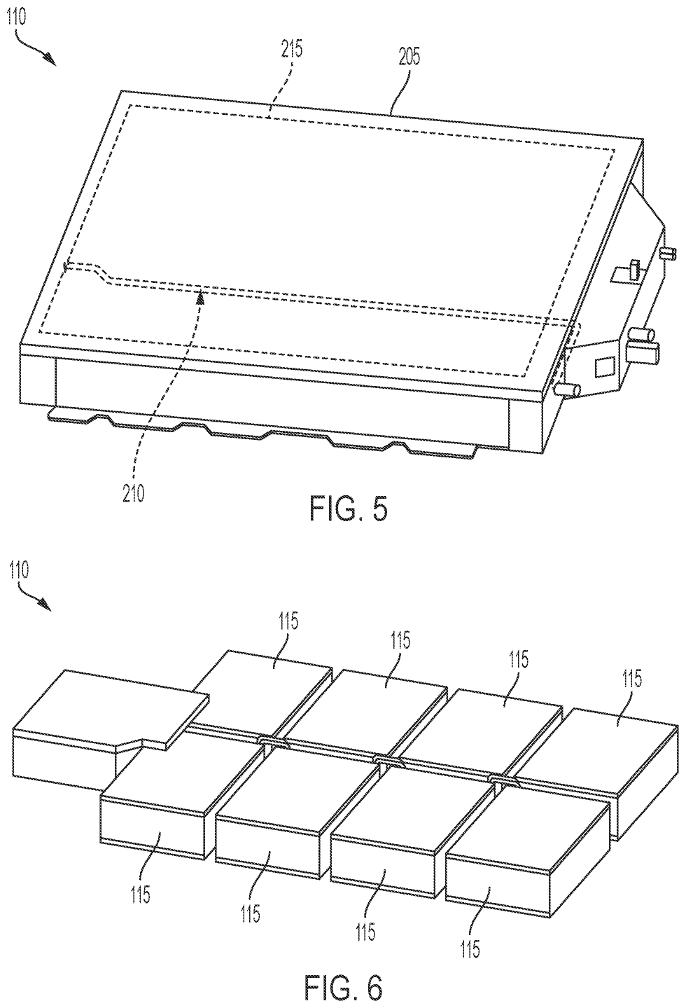

By way of illustration of the use of such batteries or battery packs in an electric vehicle, FIG. 4 depicts an illustrative cross-sectional view 100 of an electric vehicle 105 installed with at least one battery pack 110. Electric vehicle 105 may include an electric truck, electric sport utility vehicle (SUV), electric delivery van, electric automobile, electric car, electric motorcycle, electric scooter, electric passenger vehicle, electric passenger truck, electric commercial truck, hybrid vehicle, or other vehicle such as a sea or air transport vehicle, airplane, helicopter, submarine, boat, or drone, among other possibilities. The battery pack 110 may also be used as an energy storage system to power a building, such as a residential home, or commercial building. Electric vehicles 105 may be fully electric or partially electric (e.g., plug-in hybrid), and they may be fully autonomous, partially autonomous, or unmanned. Electric vehicles 105 can also be human operated or non-autonomous.

Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

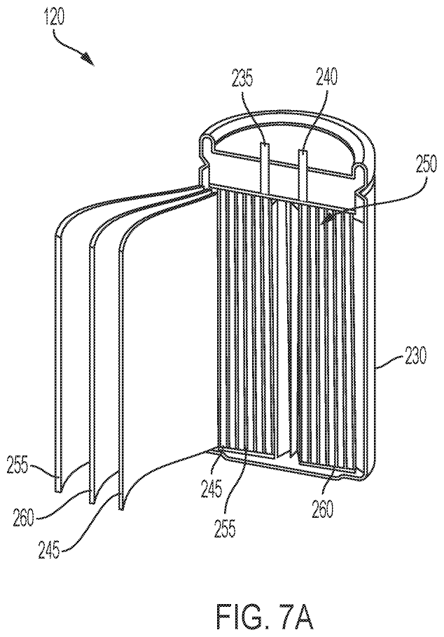

FIG. 5 depicts an illustrative battery pack 110. Referring to FIG. 5, among others, the battery pack 110 may provide power to electric vehicle 105. Battery packs 110 may include any arrangement or network of electrical, electronic, mechanical, or electromechanical devices to power a vehicle of any type, such as the electric vehicle 105. The battery pack 110 may include at least one housing 205. The housing 205 may include at least one battery module 115 or at least one battery cell 120, as well as other battery pack components. The housing 205 may include a shield on the bottom or underneath the battery module 115 to protect the battery module 115 from external conditions, for example if the electric vehicle 105 is driven over rough terrain (e.g., off-road, trenches, rocks, etc.) The battery pack 110 may include at least one cooling line 210 that can distribute fluid through the battery pack 110 as part of a thermal/temperature control or heat exchange system that may also include at least one cold plate 215. The cold plate 215 may be positioned in relation to a top submodule and a bottom submodule, such as in between the top and bottom submodules, among other possibilities. The battery pack 110 may include any number of cold plates 215. For example, there may be one or more cold plates 215 per battery pack 110, or per battery module 115. At least one cooling line 210 may be coupled with, part of, or independent from the cold plate 215.

The housing 230 of the battery cell 120 may include one or more materials with various electrical conductivity or thermal conductivity, or a combination thereof. The electrically conductive and thermally conductive material for the housing 230 of the battery cell 120 may include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 may include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

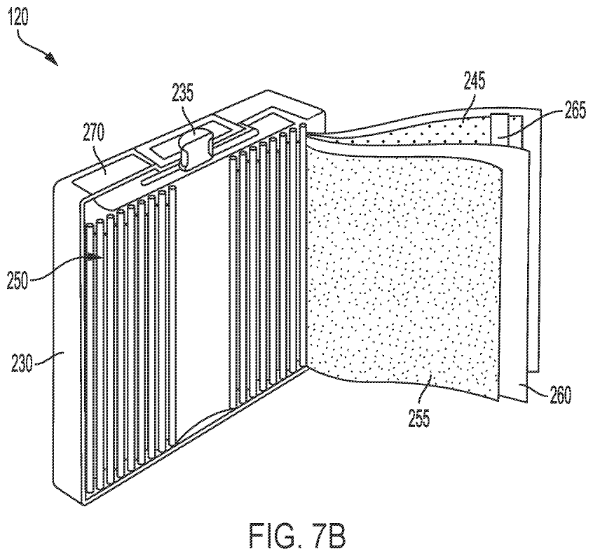

FIG. 6 depicts illustrative battery modules 115. The battery modules 115 may include at least one submodule. For example, the battery modules 115 may include at least one first (e.g., top) submodule 220 or at least one second (e.g., bottom) submodule 225. At least one cold plate 215 may be disposed between the top submodule 220 and the bottom submodule 225. For example, one cold plate 215 may be configured for heat exchange with one battery module 115. The cold plate 215 may be disposed within, or thermally coupled between, the top submodule 220 and the bottom submodule 225. One cold plate 215 may also be thermally coupled with more than one battery module 115 (or more than two submodules 220, 225). The battery submodules 220, 225 may collectively form one battery module 115. In some embodiments, each submodule 220, 225 may be considered as a complete battery module 115, rather than a submodule.

The battery modules 115 may each include a plurality of battery cells 120. The battery modules 115 may be disposed within the housing 205 of the battery pack 110. The battery modules 115 may include battery cells 120 that are cylindrical cells, prismatic cells, or other form factor cells. The battery module 115 may operate as a modular unit of battery cells 120. As an illustration, a battery module 115 may collect current or electrical power from the battery cells 120 that are included in the battery module 115 and may provide the current or electrical power as output from the battery pack 110. The battery pack 110 may include any number of battery modules 115. For example, the battery pack may have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a cold plate 215 between the top submodule 220 and the bottom submodule 225. The battery pack 110 may include, or define, a plurality of areas for positioning of the battery module 115. The battery modules 115 may be square, rectangular, circular, triangular, symmetrical, or asymmetrical. In some embodiments, battery modules 115 may be different shapes, such that some battery modules 115 are rectangular but other battery modules 115 are square shaped, among other possibilities. The battery module 115 may include or define a plurality of slots, holders, or containers for a plurality of battery cells 120.

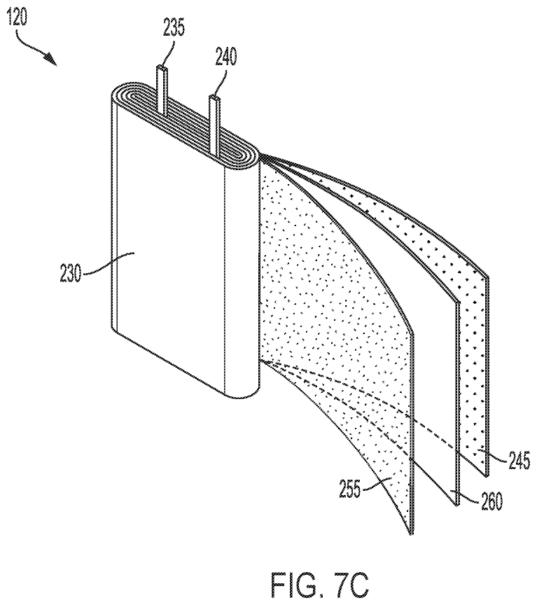

As noted above, battery cells 120 have a variety of form factors, shapes, or sizes. For example, battery cells 120 may have a cylindrical, rectangular, square, cubic, flat, or prismatic form factor. FIGS. 7A, 7B, and 7C depict illustrative cross sectional views of battery cells 120 in such various form factors. For example FIG. 7A is a cylindrical cell, 7B is a prismatic cell, and 7C is the cell for use in a pouch. The battery cells 120 may be assembled by inserting a wound or stacked electrode roll (e.g., a jellyroll) including a separator (e.g., polymeric sheet) or electrolyte material (e.g., solid state electrolyte) into at least one battery cell housing 230. The electrolyte material, e.g., an ionically conductive fluid or other material, may generate or provide electric power for the battery cell 120. In an embodiment, the separator is wetted by a liquid electrolyte during a liquid electrolyte filling operation after insertion of the jellyroll. A first portion of the electrolyte material may have a first polarity, and a second portion of the electrolyte material may have a second polarity. The housing 230 may be of various shapes, including cylindrical or rectangular, for example. Electrical connections may be made between the electrolyte material and components of the battery cell 120. For example, electrical connections with at least some of the electrolyte material may be formed at two points or areas of the battery cell 120, for example to form a first polarity terminal 235 (e.g., a positive or anode terminal) and a second polarity terminal 240 (e.g., a negative or cathode terminal). The polarity terminals may be made from electrically conductive materials to carry electrical current from the battery cell 120 to an electrical load, such as a component or system of the electric vehicle 105.

The battery cell 120 may include at least one anode layer 245, which may be disposed within the cavity 250 defined by the housing 230. The anode layer 245 may receive electrical current into the battery cell 120 and output electrons during the operation of the battery cell 120 (e.g., charging or discharging of the battery cell 120). The anode layer 245 may include an active substance.

The battery cell 120 may include at least one cathode layer 255 (e.g., a composite cathode layer compound cathode layer, a compound cathode, a composite cathode, or a cathode). The cathode layer 255 may be disposed within the cavity 250. The cathode layer 255 may output electrical current out from the battery cell 120 and may receive electrons during the discharging of the battery cell 120. The cathode layer 255 may also release lithium ions during the discharging of the battery cell 120. Conversely, the cathode layer 255 may receive electrical current into the battery cell 120 and may output electrons during the charging of the battery cell 120. The cathode layer 255 may receive lithium ions during the charging of the battery cell 120.

The battery cell 120 may include a polymer separator comprising a liquid electrolyte in the case of Li-ion batteries or an electrolyte layer 260 in the case of solid-state batteries, disposed within the cavity 250. The separator or electrolyte layer 260 may be arranged between the anode layer 245 and the cathode layer 255 to separate the anode layer 245 and the cathode layer 255. The liquid electrolyte or solid-state electrolyte layer 260 may transfer ions between the anode layer 245 and the cathode layer 255. The liquid or solid electrolytescan transfer cations (e.g., Li⁺ ions) from the anode layer 245 to the cathode layer 255 during a discharge operation of the battery cell 120. The liquid or solid electrolyte can transfer cations (e.g., Li⁺ ions) from the cathode layer 255 to the anode layer 245 during a charge operation of the battery cell 120.

FIG. 7B is an illustration of a prismatic battery cell 120. The prismatic battery cell 120 may have a housing 230 that defines a rigid enclosure. The housing 230 may have a polygonal base, such as a triangle, square, rectangle, pentagon, among others. For example, the housing 230 of the prismatic battery cell 120 may define a rectangular box. The prismatic battery cell 120 may include at least one anode layer 245, at least one cathode layer 255, and at least one separator and electrolyte or an electrolyte layer 260 disposed within the housing 230. The prismatic battery cell 120 may include a plurality of anode layers 245, cathode layers 255, and separator or electrolyte layers 260. For example, the layers 245, 255, 260 may be stacked or in a form of a flattened spiral. The prismatic battery cell 120 may include an anode tab 265. The anode tab 265 may contact the anode layer 245 and facilitate energy transfer between the prismatic battery cell 120 and an external component. For example, the anode tab 265 may exit the housing 230 or electrically couple with a positive terminal 235 to transfer energy between the prismatic battery cell 120 and an external component.

The battery cell 120 may also include a pressure vent 270. The pressure vent 270 may be disposed in the housing 230. The pressure vent 270 may provide pressure relief to the battery cell 120 as pressure increases within the battery cell 120. For example, gases may build up within the housing 230 of the battery cell 120. The pressure vent 270 may provide a path for the gases to exit the housing 230 when the pressure within the battery cell 120 reaches a threshold.

The present invention, thus generally described, will be understood more readily by reference to the following examples, which are provided by way of illustration and are not intended to be limiting of the present invention.

### EXAMPLES

General. First-principles density functional theory (DFT)-based methodologies can be used to determine, understand, and pre-select materials LiₐM_{b}O_{c}, materials for coating of NMC materials. The DFT algorithms are used calculate the thermodynamic stability of the materials, to identify those material shaving stable ground state structures vs. high-energy structures.

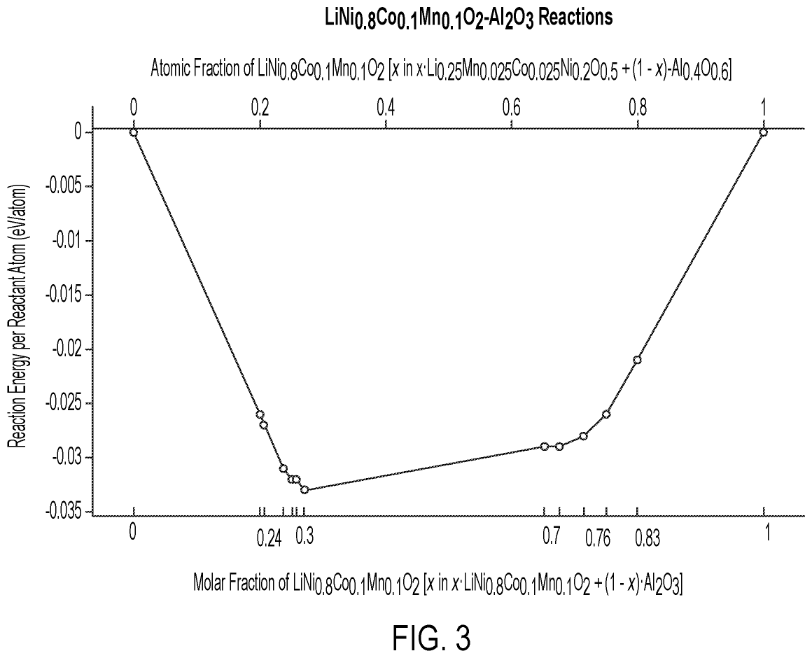

The screening strategy employed the following criteria to identify additional protective coating materials using NMC811 powders as an illustrative example of NMC materials more generally. The criteria included: (a) lithium content; (b) stability/synthesizability; (c) electronic insulation; (d) equilibrium with the NMC811 cathode material; (e) equilibrium/no reaction with commercially used binary metal oxide coatings; (f) electrolyte stability by predicting an equilibrium or no reaction with LiOH and LiF while scavenging corrosive species such as PFS; and (g) exhibiting good electrochemical performance (i.e. high ionic conductivity and redox potential). Halide containing compounds were also excluded due to potential long-term corrosive effects. FIG. 2 is a diagram of the workflow and criteria.

The thermodynamic stability is quantified based on the energy of the compound above the convex hull (Eₕᵤₗₗ) in the chemical space of elements which make up the material and such data are readily acquired from the materials project database. A compound with Eₕᵤₗₗ=0 lies in the energy convex hull and is a thermodynamically stable phase at T=0 K. A compound with Eₕᵤₗₗ>0 is thermodynamically metastable and a material with a high energy above hull (e.g., >50 meV/atom) may have a strong driving force to decomposition and would be difficult to synthesize experimentally.

To identify coatings that are electronically insulating, compounds exhibiting a DFT bandgap above 1.0 eV were identified.

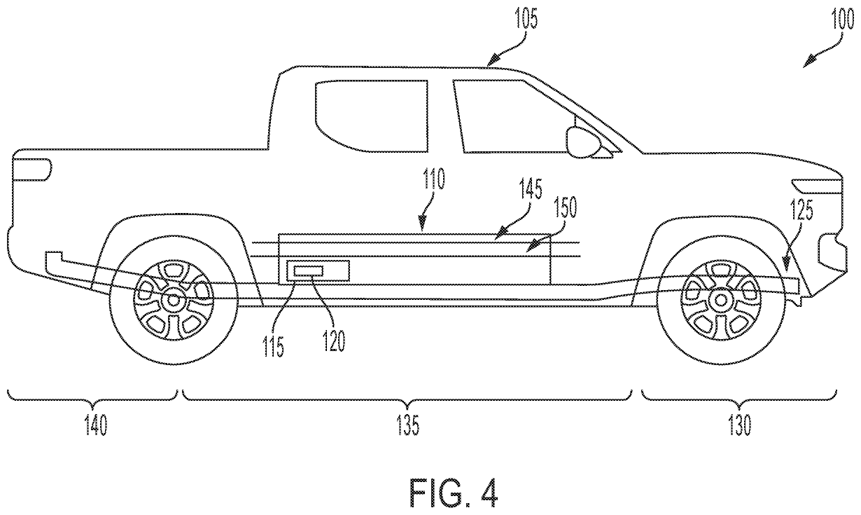

Another screening step included determining if the LiₐM_{b}O_{c}, exhibits a chemical equilibrium with the NMC811 cathode material. It is preferred that either no reaction is found, or if there is a reaction it is at equilibrium so that overall compositional changes are not imparted to the electrode. To compute whether a compound exhibits equilibrium with the electrode materials, the convex hull method was used. For each candidate compound, the convex hull is calculated for the set of elements defined by the compound plus the electrolyte material. Within the convex hull, tie lines connecting the candidate compound with the electrolyte material are analyzed. The presence of a tie line is an indication that the candidate compound does exhibit stable equilibrium with the electrode. The absence of such a tie line indicates that the candidate compound does not exhibit stable equilibrium with the electrolyte but rather reacts. FIG. 3 shows the case study of utilizing Al₂O₃ as a coating candidate. The x-axis shows the molar fraction of NMC811, where x=0 is 100% NMC811 and x=1 is 100% Al₂O₃. The y-axis describes the reaction enthalpy in eV/atom. The most stable reaction between NMC811 and Al₂O₃ occurs when x=0.319, with Eᵣₓₙ=−0.033 eV/atom. Accordingly, the graph shows that Al₂O₃ will react with NMC811 electrolyte, where the most energetically favorable chemical reaction is:

0 0.319 Li₁Mn_{0.1}Co_{0.1}Ni_{0.8}O₂+0.681 Al₂O₃→0.003 LiO₈+0.082 Ni₃O₄+0.273 LiAl₅O₈+0.006 Li₄MnCo₅O₁₂+0.008 Li₂Mn₃NiO₈

This reaction has a Eᵣₓₙ value of −0.033 eV/atom.

Al₂O₃ is a commonly applied coating material on Li-ion battery cathode powders, and is generally considered to provide a stable protective layer. The stability of various LiₐM_{b}O_{c} compounds was determined with respect to NMC811, and this was then normalized to the case of Al₂O₃. Illustrative LiₐM_{b}O_{c} compounds are shown in Table 1, where it is preferable that the coating material be determined to be in chemical equilibrium with the NMC811. For example, as shown in Table 1, 0.681 Al₂O₃ (conventional cathode coating) reacts with 0.319 Li₁Mn_{0.1}Co_{0.1}Ni_{0.8}O₂ to form 0.113 0.003 LiO₈, 0.082 Ni₃O₄, 0.273 LiAl₅O₈, 0.006 Li₄MnCo₅O₁₂ and 0.008 Li₂Mn₃NiO₈, with an Eᵣₓₙ, of −0.033 eV/atom. The ratio of NMC811:Al₂O₃ is 0.319/0.681, or 0.468, for the reaction.

In Table 1, the NMC811 stability performance of the illustrated LiₐM_{b}O_{c} compounds vs. Al₂O₃ is tablulated. In the Table, LiYO₂ has a ratio for NMC811: LiYO₂ of 0.416, and a “Ratio vs Al₂O₃” of 0.888. For NMC811 reaction, it is beneficial if the “Ratio” value of the coating is lower when compared to that of NMC811:Al₂O₃, or in other words, the oxide coating consumes less NMC811 than Al₂O₃. Similarly, it is desirable that the Eᵣₓₙ of NMC811 versus the LiₐM_{b}O_{c} coating material be higher (i.e., less favorable to react with NMC811) compared to NMC811 v. Al₂O₃ reaction. The Eᵣₓₙ of the screened LiₐM_{b}O_{c} coatings vs. Al₂O₃ is presented in the column marked “Eᵣₓₙ vs. Al₂O₃.”

The two values that are referenced to Al₂O₃ for molar ratio and reaction enthalpy are then added. Because these values are evaluated based on the molar fraction, they are then converted by dividing by molecular weight: e.g., 2.00/101.961×1,000=19.615 for Al₂O₃. In the last column (the ‘NMC-Score’), the percentage improvement vs. Al₂O₃, or the NMC stability score for all the screened LiₐM_{b}O_{c} materials is provided. For example, for LiYO₂, the calculation is: 19.615/7.6×100=255.94% for LiYO₂. For any LiₐM_{b}O_{c} coating material that does not react with NMC811, as a qualitative measurement, the NMC-score is regarded as “Excellent.” An “NMC Score”>100 indicates that the LiₐM_{b}O_{c} compound is expected to have better stability with regard to NMC811, compared to Al₂O₃. A number of compounds that were found to exhibit better performance for NMC811 stability, when compared with the state-of-art Al₂O₃ material are listed in Table 1.

TABLE 1
Chemical stability with NMC811.

| | | | Ratio vs. | Eᵣₓₙ | Eᵣₓₙ vs. | NMC |
|---|---|---|---|---|---|---|
| Material | Reaction With NMC811 | Ratio | Al₂O₃ | (Ev/Atom) | Al₂O₃ | Score |
| Al₂O₃ | 0.319 Li₁Mn_{0.1}Co_{0.1}Ni_{0.8}O₂ + 0.681 Al₂O₃ | 0.468 | 1 | −0.033 | 1 | 100 |
| | → 0.003 LiO₈ + 0.082 Ni₃O₄ + 0.273 | | | | | |
| | LiAl₅O₈ + 0.006 Li₄MnCo₅O₁₂ + 0.008 | | | | | |
| | Li₂Mn₃NiO₈ | | | | | |
| Li₅AlO₄ | No Reaction | N/A | N/A | 0 | 0 | Excellent |
| Li₃SbO₄ | No Reaction | N/A | N/A | 0 | 0 | Excellent |
| Li₂SO₄ | No Reaction | N/A | N/A | 0 | 0 | Excellent |
| LiSCO₂ | No Reaction | N/A | N/A | 0 | 0 | Excellent |
| Li₄MoO₅ | No Reaction | N/A | N/A | 0 | 0 | Excellent |
| Li₃NbO₄ | No Reaction | N/A | N/A | 0 | 0 | Excellent |
| Li₄TiO₄ | No Reaction | N/A | N/A | 0 | 0 | Excellent |
| LiFeO₂ | No Reaction | N/A | N/A | 0 | 0 | Excellent |
| Li₅SbO₅ | No Reaction | N/A | N/A | 0 | 0 | Excellent |
| Li₆Hf₂O₇ | No Reaction | N/A | N/A | 0 | 0 | Excellent |
| LiYO₂ | 0.294 Li₁Mn_{0.1}Co_{0.1}Ni_{0.8}O₂ + 0.706 LiYO₂ | 0.416 | 0.888 | −0.003 | 0.091 | 255.942 |
| | → 0.176 Li₅NiO₄ + 0.029 Li₂CoO₃ + 0.029 | | | | | |
| | Li₂MnO₃ + 0.353 Y₂O₃ + 0.059 NiO | | | | | |
| Li₇SbO₆ | 0.545 Li₇SbO₆ + 0.455 | 0.835 | 1.784 | −0.01 | 0.303 | 250.298 |
| | Li₁Mn_{0.1}Co_{0.1}Ni_{0.8}O₂ → 0.545 Li₅SbO₅ + | | | | | |
| | 0.273 Li₅NiO₄ + 0.045 Li₂CoO₃ + 0.045 | | | | | |
| | Li₂MnO₃ + 0.091 NiO | | | | | |
| Li₈TiO₆ | 0.375 Li₈TiO₆ + 0.625 | 1.667 | 3.561 | −0.008 | 0.242 | 102.801 |
| | Li₁Mn_{0.1}Co_{0.1}Ni_{0.8}O₂ → 0.375 Li₅NiO₄ + | | | | | |
| | 0.062 Li₂CoO₃ + 0.375 Li₄TiO₄ + 0.063 | | | | | |
| | Li₂MnO₃ + 0.125 NiO | | | | | |
| Li₈ZrO₆ | 0.676 Li₁Mn_{0.1}Co_{0.1}Ni_{0.8}O₂ + 0.324 | 2.086 | 4.457 | −0.007 | 0.212 | 101.971 |
| | Li₈ZrO₆ → 0.405 Li₅NiO₄ + 0.068 Li₂CoO₃ + | | | | | |
| | 0.162 Li₆Zr₂O₇ + 0.068 Li₂MnO₃ + 0.135 | | | | | |
| | NiO | | | | | |

The stability of the screened LiₐM_{b}O_{c} compounds was then further screened against other common NMC coating materials to determine if the LiₐM_{b}O_{c} compounds will be in equilibrium with (i.e. stable with) such common NMC coatings. The common coatings evaluated were: Al₂O₃, MgO, ZrO₂, TiO₂, MnO₂, Y₂O₃, Nb₂O₅, SnO₂, HfO₂, WO₃, LiNbO₃, Li₄WO₅, and Li₂WO₄. Because LiNbO₃ is a regularly used coating material for commercial NMC cathode powders, we compared the stability performance of the screened LiₐM_{b}O_{c} compounds against LiNbO₃. For each of the commercial coatings listed above, a “coating stability score” was determined vs LiNbO₃ using the identical approach detailed in the previous section. The commercial coatings mentioned above, were then ranked with regard to the screened LiₐM_{b}O_{c} compounds based on their “coating stability score.” Finally, for each screened LiₐM_{b}O_{c} compounds, the weighted average of the individual coating stability ranks was determined. It is to be noted that, based on the vendor usage and reports in the literature, while computing the the weighted average of ranks for each of the LiₐM_{b}O_{c} compounds, ZrO₂ and LiBO₃ coating stability ranks are provided twice the weight, and the A1203 coating stability ranks is provided four times the weight in comparison to the other coating stability ranks. A number of the LiₐM_{b}O_{c} compounds screened based on the weighted average of the coating stability ranks for various commercial coatings are listed in Table 2.

TABLE 2
Screened 30 LiₐM_{b}O_{c} materials based on chemical stability against various commercially
used NMC coatings. For each LiₐM_{b}O_{c}, the coating stability rank for various commercial
coatings as well the weighted average of all the ranks is provided. For a particular commercial
coating, LiₐM_{b}O_{c} materials having similar stability score(s) are given the same rank.

| | | | | | | | | | | | | | | Weighted |
|---|---|---|---|---|---|---|---|---|---|---|---|---|---|---|
| Materials | Al₂O₃ | MgO | ZrO₂ | TiO₂ | MnO₂ | Y₂O₃ | Nb₂O₅ | SnO₂ | HfO₂ | WO₃ | LiBO₃ | Li₄WO₅ | Li₂WO₄ | Average |
| LiNO₃ | 1 | 1 | 1 | 1 | 1 | 2 | 1 | 1 | 1 | 1 | 1 | 1 | 1 | 1.055 |
| Li₂SO₄ | 1 | 1 | 1 | 1 | 1 | 2 | 1 | 1 | 1 | 1 | 1 | 1 | 1 | 1.055 |
| Li₂MoO₄ | 18 | 1 | 1 | 1 | 1 | 2 | 1 | 1 | 1 | 1 | 1 | 1 | 1 | 4.833 |
| Li₂CrO₄ | 1 | 1 | 1 | 1 | 1 | 2 | 1 | 1 | 1 | 1 | 70 | 1 | 1 | 8.722 |
| LiGaO₂ | 25 | 1 | 1 | 1 | 22 | 2 | 15 | 1 | 1 | 15 | 1 | 1 | 1 | 9.111 |
| Li₃PO₄ | 51 | 1 | 1 | 1 | 1 | 2 | 1 | 1 | 1 | 1 | 1 | 1 | 1 | 12.166 |
| Li₂MnO₃ | 36 | 1 | 1 | 1 | 28 | 2 | 25 | 1 | 1 | 17 | 1 | 1 | 1 | 12.555 |
| Li₃VO₄ | 45 | 1 | 1 | 1 | 17 | 2 | 18 | 1 | 1 | 1 | 1 | 1 | 1 | 12.666 |
| LiSbO₃ | 14 | 1 | 1 | 1 | 1 | 64 | 1 | 1 | 1 | 1 | 57 | 1 | 1 | 13.611 |
| Li₃SbO₄ | 29 | 20 | 1 | 25 | 29 | 2 | 28 | 1 | 1 | 27 | 1 | 1 | 24 | 15.444 |
| Li₃NbO₄ | 35 | 17 | 1 | 22 | 30 | 2 | 27 | 1 | 1 | 25 | 1 | 1 | 21 | 16.166 |
| Li₂SnO₃ | 24 | 22 | 1 | 33 | 36 | 2 | 36 | 1 | 1 | 35 | 1 | 1 | 26 | 16.277 |
| Li₂HfO₃ | 20 | 26 | 1 | 37 | 26 | 2 | 30 | 30 | 1 | 38 | 1 | 1 | 32 | 17.055 |
| Li₃BiO₄ | 16 | 26 | 1 | 35 | 23 | 2 | 26 | 32 | 34 | 34 | 1 | 1 | 32 | 17.388 |
| LiNb₃O₈ | 9 | 26 | 1 | 1 | 10 | 6 | 1 | 1 | 1 | 1 | 61 | 63 | 1 | 18.111 |
| Li₂TiO₃ | 50 | 1 | 1 | 18 | 43 | 2 | 33 | 1 | 1 | 23 | 1 | 1 | 1 | 18.222 |
| Li₂GeO₃ | 31 | 1 | 1 | 17 | 24 | 2 | 22 | 1 | 1 | 14 | 63 | 1 | 1 | 18.666 |
| Li₈Nb₂O₉ | 1 | 26 | 33 | 30 | 25 | 2 | 20 | 33 | 35 | 32 | 1 | 1 | 28 | 19.111 |
| LiSb₃O₈ | 5 | 43 | 1 | 1 | 1 | 63 | 1 | 1 | 1 | 1 | 60 | 69 | 36 | 19.944 |
| LiFeO₂ | 41 | 21 | 1 | 29 | 51 | 2 | 51 | 1 | 1 | 30 | 1 | 1 | 25 | 21.111 |
| Li₄Ge₅O₁₂ | 7 | 35 | 38 | 1 | 13 | 57 | 11 | 1 | 27 | 1 | 62 | 64 | 1 | 24.388 |
| Li₆Hf₂O₇ | 15 | 39 | 40 | 45 | 18 | 2 | 24 | 41 | 40 | 47 | 1 | 1 | 43 | 24.555 |
| Li₂fFeO₃ | 43 | 23 | 1 | 35 | 50 | 2 | 50 | 28 | 27 | 36 | 1 | 1 | 30 | 25.444 |
| Li₄SiO₄ | 48 | 23 | 1 | 32 | 55 | 2 | 45 | 29 | 27 | 31 | 1 | 1 | 28 | 26.055 |
| Li₂Ge₂O₅ | 12 | 32 | 37 | 1 | 15 | 58 | 17 | 1 | 27 | 13 | 66 | 62 | 1 | 26.722 |
| Li₄MoO₅ | 28 | 39 | 39 | 40 | 33 | 2 | 37 | 42 | 40 | 39 | 1 | 1 | 42 | 28.166 |
| Li₂ZrO₃ | 44 | 35 | 1 | 42 | 48 | 2 | 48 | 38 | 37 | 42 | 1 | 1 | 40 | 28.5 |
| Li₆Ge₂O₇ | 13 | 32 | 35 | 31 | 19 | 1 | 23 | 36 | 36 | 29 | 56 | 57 | 32 | 29.444 |
| Li₄GeO₄ | 38 | 35 | 34 | 39 | 40 | 2 | 42 | 37 | 38 | 37 | 1 | 1 | 39 | 29.555 |
| Li₅SbO₅ | 33 | 42 | 42 | 43 | 39 | 2 | 38 | 44 | 45 | 44 | 1 | 1 | 44 | 31.11 |

Electrolyte decomposition leads to the formation of the desirable solid electrolyte interface (SEI). The SEI is primarily composed of LiF, Li₂O, Li₂CO₃ and other insoluble products. Enriching the SEI with LiF has recently gained popularity to improve Li cyclability. Here, it is desirable that the LiₐM_{b}O_{c} coatings not to consume LiF, so that it remains available for the SEI formation. LiOH may also be present at the surface of cathode materials, depending on the choice of Li salt precursors. The presence of LiOH leads to the formation of H₂O within the cell, and this can subsequently form HF. Similar to LiF, it is desirable that the LiOH reaction not take place when in contact with the LiₐM_{b}O_{c} compounds, to avoid the H₂O formation.

Accordingly, the stability of the screened LiₐM_{b}O_{c} compounds was then further evaluated with respect to LiF and LiOH. The compounds were also ranked in comparison to LiNbO₃, using the same approach as above.

PF₅⁻ is another species that often forms in electrolyte due to LiPF₆ degradation according to the equation: LiPF₆↔LiF+PF₅. PF₅⁻ can be harmful and decompose NMC811. Thus, it would be desirable if the LiₐM_{b}O_{c} coating scavenges PF₅⁻ that may be present in the electrolyte/cell. Therefore, the reactivity scores of the LiₐM_{b}O_{c} materials were also determined and ranked in comparison to LiNbO₃. The weighted average of the LiF stability, LiOH stability, and PF₅⁻ were also determined and are listed in Table 3.

TABLE 3
Screened LiₐM_{b}O_{c} compounds based on electrolyte stability.
For each LiₐM_{b}O_{c} compound, LiF stability, LiOH stability, and PF₅⁻
reactivity ranks, as well the weighted average of three ranks
are provided. For a particular criterion, LiₐM_{b}O_{c} materials having
similar performance scores are given the same rank.

| | LiF | LiOH | PF₅⁻ | Weighted |
|---|---|---|---|---|
| | Stability | Stability | Reactivity | Average |
| Material | Rank | Rank | Rank | of Ranks |
| Li₆Hf₂O₇ | 1 | 1 | 1 | 1 |
| Li₈Nb₂O₉ | 1 | 1 | 3 | 1.667 |
| Li₆Ge₂O₇ | 1 | 1 | 4 | 2 |
| Li₃BiO₄ | 1 | 1 | 7 | 3 |
| Li₂HfO₃ | 1 | 1 | 8 | 3.333 |
| Li₄WO₅ | 1 | 1 | 9 | 3.667 |
| Li₃SbO₄ | 1 | 1 | 10 | 4 |
| Li₄GeO₄ | 1 | 1 | 12 | 4.667 |
| Li₂SnO₃ | 1 | 1 | 13 | 5 |
| Li₄MoO₅ | 1 | 1 | 14 | 5.333 |
| Li₃NbO₄ | 1 | 1 | 15 1 | 5.667 |
| Li₂ZrO₃ | 1 | 1 | 16 | 6 |
| Li₄SiO₄ | 1 | 1 | 17 | 6.333 |
| Li₂GeO₃ | 1 | 1 | 18 | 6.667 |
| Li₂FeO₃ | 1 | 1 | 20 | 7.333 |
| Li₂TiO₃ | 1 | 1 | 21 | 7.667 |
| Li₃VO₄ | 1 | 1 | 22 | 8 |
| Li₂MnO₃ | 1 | 1 | 23 | 8.333 |
| Li₂MoO₄ | 1 | 1 | 24 | 8.667 |
| Li₂CrO₄ | 1 | 1 | 25 | 9 |

The cathode coating layer should be ionically conductive under cell operating conditions to reduce the interfacial resistance and the cell overpotential. Usually, compounds containing lithium sub-lattices enable better lithium diffusivity than binary metal oxides (e.g., Al₂O₃). Therefore, the Li containing oxide compounds screened here are expected to have better ionic conductivity compared to the state-of-art binary oxide coatings (e.g., Al₂O₃). A machine learning model was used to predict the ionic conductivity of the LiₐM_{b}O_{c} compound. The rank of the LiₐM_{b}O_{c} compounds, based on their predicted ionic conductivity, is shown in Table 4. For a cathode coating to be effective, the oxidation limits should also be high enough for it to be stable at the top of the charge. Table 4 also ranks the screened compounds, based on their oxidation potential.

TABLE 4
Ionic Conductivity and Oxidation Potential ranking
of screened LiₐM_{b}O_{c} compounds.

| | Predicted | Con- | | | |
|---|---|---|---|---|---|
| | Log(Ionic | ductivity | Ox | Ox | Weighted |
| Material | Conductivity) | Rank | Potential | Rank | Average |
| Li₃SbO₄ | −5.652 | 1 | 3.556 | 8 | 4.5 |
| Li₃VO₄ | −8.036 | 8 | 3.950 | 3 | 5.5 |
| Li₂SnO₃ | −5.751 | 2 | 3.506 | 10 | 6 |
| Li₆Ge₂O₇ | −7.941 | 7 | 3.606 | 7 | 7 |
| Li₂MnO₃ | −6.520 | 4 | 3.484 | 11 | 7.5 |
| Li₂FeO₃ | −7.207 | 6 | 3.516 | 9 | 7.5 |
| Li₃NbO₄ | −8.369 | 10 | 3.620 | 6 | 8 |
| Li₂GeO₃ | −8.789 | 13 | 3.835 | 4 | 8.5 |
| Li₂MoO₄ | −9.639 | 16 | 4.053 | 2 | 9 |
| Li₂CrO₄ | −9.723 | 17 | 4.137 | 1 | 9 |
| Li₂HfO₃ | −6.689 | 5 | 3.378 | 14 | 9.5 |
| Li₄MoO₅ | −5.942 | 3 | 3.293 | 18 | 10.5 |
| LiGaO₂ | −10.235 | 19 | 3.805 | 5 | 12 |
| Li₃BiO₄ | −8.609 | 12 | 3.440 | 12 | 12 |
| Li₂ZrO₃ | −9.085 | 14 | 3.386 | 13 | 13.5 |
| Li₈Nb₂O₉ | −8.503 | 11 | 3.348 | 16 | 13.5 |
| Li₆HF₂O₇ | −8.174 | 9 | 3.218 | 20 | 14.5 |
| Li₂TiO₃ | −9.440 | 15 | 3.314 | 17 | 16 |
| Li₄GeO₄ | −10.428 | 20 | 3.359 | 15 | 17.5 |
| Li₄SiO₄ | −10.188 | 18 | 3.265 | 19 | 18.5 |

Experimental procedure. Dry- or solution-phase methods may be used to deposit the LiₐM_{b}O_{c} coatings on commercial NMC811 powders.

Solution-Phase. Under an argon atmosphere, lithium and M_{d}(C₂H₅O)ₑ are dissolved in ethanol, and the resulting solution is stirred for about an hour. NCM811 is then added to the ethanol solution and the resulting solution is stirred for another hour before removing the ethanol under heating at about 60-80° C., to leave a residual gel. The gel is then sintered at about 400-500° C. for aboutl hour in a tube furnace under an O₂ flush to form a LiₐM_{b}O_{c}-coated NCM811. A similar approach has been successfully applied for coating NMC811 with LiNbO₃.

Dry-Phase. Commercial NMC811 powder and nanostructured LiₐM_{b}O_{c} is used. The NMC-powder is mixed with an appropriate amount of the respective fumed metal oxide powder in a high energy mixer for about 1 minute to about 5 minutes at about 500-1000 rpm to homogeneously mix the powders using a solid-state method. After 1 to 5 minutes, the mixing intensity was increased to about 1500-2000 rpm for 5-10 mins to further break down and mill the ternary oxide into smaller aggregates that adhere at the surface of NMC powder. The coated NMC811 so formed is not further calcined, but may be subject to secondary heat treatment depending on the composition of LiₐM_{b}O_{c}. In another emobodiment, this process may accompany aqueous solution (neutral, acid, base) or organic solvent, where the precusor may or may not have the solubility. If materials do not dissolve or have limited solublity, the coating can be formed via wet-milling process. If materials have solubility, it will precipitate out as a solid phase at the surface of the cathode and first coating from the liquid phase. A similar approach can be used to coat cathode active material with metal oxides (e.g., Al₂O₃, TiO₂, etc.).

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions that can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A cathode active material comprising:
a nickel-rich lithium transition metal oxide;
a first coating material on a surface of the nickel-rich lithium transition metal oxide; and
a second coating material comprising a lithium metal oxide coating;
wherein the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide, and the second coating material is different from the first coating material and the nickel-rich lithium transition metal oxide.

2. The cathode active material of claim 1, wherein the second coating material is other than a lithium aluminum oxide.

3. The cathode active material of claim 1, wherein the second coating material exhibits:
a chemical stability with the nickel-rich lithium transition metal oxide greater than that of Al₂O₃;
a chemical stability with the first coating greater than that of LiNbO₃;
a LiF stability score greater than that of LiNbO₃;
a PF₅⁻ reactivity score greater than that of LiNbO₃,
a thermodynamic phase stability or synthesizability measured by energy above hull <100 meV/atom;
a band gap energy greater than 1 eV; or
a combination of any two or more thereof.

4. The cathode active material of claim 1, wherein the first coating material comprises a binary metal oxide coating.

5. The cathode active material of claim 1, wherein a ratio of the first coating material to the second coating material is 1:1, 2:1, 3:1, 4:1, or 5:1 on a wt % basis.

6. The cathode active material of claim 1, wherein the second coating material exhibits a nickel-rich transition metal oxide stability score of greater than that of Al₂O₃ coating.

7. The cathode active material of claim 1, wherein the lithium metal oxide of the second coating material is present from greater than 0.01 wt % to about 5.0 wt %.

8. The cathode active material of claim 1, wherein the second coating material has a thickness on the bulk cathode active material of about 5 nm to about 2 μm.

9. The cathode active material of claim 1, wherein the first coating material comprises discontinuous regions, and wherein a portion of the second coating material is formed in the discontinuous regions of the first coating material.

10. The cathode active material of claim 9, wherein the portion of the second coating material is formed in the discontinuous regions of the first coating layer and has a greater thickness than other portions of the second coating material formed as an overcoating.

11. The cathode active material of claim 1, wherein the second coating material is other than Al₂O₃, HfO₂, MgO, MnO₂, Nb₂O₅, SnO₂, TiO₂, WO₃, Y₂O₃, ZrO₂, LiNbO₃, LiBO₃, Li₂WO₄, Li₄WO₅, or a mixture of any two or more thereof.

12. The cathode active material of claim 1, wherein:
the first coating material comprises Al₂O₃, HfO₂, MgO, MnO₂, Nb₂O₅, SnO₂, TiO₂, WO₃, Y₂O₃, ZrO₂, LiNbO₃, LiBO₃, Li₂WO₄, Li₄WO₅, or a mixture of any two or more thereof;
the second coating is of formula LiₐM_{b}O_{c};
M is Bi, Cr, Fe, Ga, Ge, Hf, Mn, Mo, Nb, Sb, Si, Sn, Ti, V, or Zr;
a is 0, 1, 2, 3, 4, 5, 6, 7, or 8;
b is 0, 1, or 2; and
c is 1, 2, 3, 4, 5, 6, 7, 8, or 9.

13. The cathode active material of claim 1, wherein the second coating material comprises Li₃SbO₄, Li₃VO₄, Li₂SnO₃, Li₆Ge₂O₇, Li₂FeO₃, Li₃NbO₄, Li₂MnO₃, Li₂MoO₄, Li₄MoO₅, Li₂CrO₄, Li₂HfO₃, LiGaO₂, Li₂GeO₃, Li₃BiO₄, Li₂ZrO₃, Li₈Nb₂O₉, Li₂TiO₃, Li₄GeO₄, Li₄SiO₄, or a mixture of any two or more thereof.

14. The cathode active material of claim 1, wherein the second coating material comprises Li₃SbO₄, Li₃VO₄, Li₂SnO₃, Li₆Ge₂O₇, Li₂FeO₃, Li₃NbO₄, Li₂MnO₃, Li₂MoO₄, Li₄MoO₅, Li₂CrO₄, Li₂HfO₃, LiGaO₂, Li₂GeO₃, or a mixture of any two or more thereof.

15. The cathode active material of claim 1, wherein the second coating material comprises Li₃SbO₄, Li₃VO₄, Li₂SnO₃, Li₆Ge₂O₇, Li₂FeO₃, or a mixture of any two or more thereof.

16. The cathode active material of claim 1, wherein the nickel-rich lithium transition metal oxide comprises a lithium nickel manganese cobalt oxide (“LiNMC”), a lithium nickel cobalt aluminum oxide (“LiNCA”), or a lithium nickel manganese cobalt aluminum oxide (“LiNMCA”) material.

17. The cathode active material of claim 1, wherein the nickel-rich lithium transition metal oxide comprises LiNi_{0.8}Mn_{0.1}Co_{0.1}O₂.

18. A battery comprising a cathode, an anode, and a solid-state electrolyte, wherein:
the cathode comprises:
a nickel-rich lithium transition metal oxide;
a first coating material on a surface of the nickel-rich lithium transition metal oxide; and
a second coating material comprising a lithium metal oxide coating;
wherein the second coating material overcoats the first coating material, fills in voids of the first coating material on the surface of the nickel-rich lithium transition metal oxide, or both overcoats the first coating material and fills in voids of the first coating material on the surface of the nickel-rich lithium transition metal oxide, and the second coating material is different from the first coating material and the nickel-rich lithium transition metal oxide.

19. The battery of claim 18, wherein the lithium metal oxide comprises Li₃SbO₄, Li₃VO₄, Li₂SnO₃, Li₆Ge₂O₇, Li₂FeO₃, Li₃NbO₄, Li₂MnO₃, Li₂MoO₄, Li₄MoO₅, Li₂CrO₄, Li₂HfO₃, LiGaO₂, Li₂GeO₃, Li₃BiO₄, Li₂ZrO₃, Li₈Nb₂O₉, Li₂TiO₃, Li₄GeO₄, Li₄SiO₄, or a mixture of any two or more thereof.

20. The battery of claim 18, wherein the solid-state electrolyte comprises Li₃PS₄, Li₇P₃S₁₁, Li₂S-P₂S₅ or Li₆PS₅Cl.
